(19) United States
(12) Patent Application Publication
(10) Pub. No.: US 2019/0119074 A1
(43) Pub. Date: Apr. 25, 2019

(54) ELEVATOR ARRANGEMENT FOR SAFE MAINTENANCE WORK

(71) Applicant: Kone Corporation, Helsinki (FI)

(72) Inventors: Markku HAAPANIEMI, Helsinki (FI); Matti RASANEN, Helsinki (FI); Janne MIKKONEN, Helsinki (FI); Ari KATTAINEN, Helsinki (FI); Esko AULANKO, Kerava (FI)

(73) Assignee: Kone Corporation, Helsinki (FI)

(21) Appl. No.: 16/220,319

(22) Filed: Dec. 14, 2018

Related U.S. Application Data
(63) Continuation of application No. PCT/FI2016/050525, filed on Jul. 15, 2016.

(51) Int. Cl. B66B 11/02; B66B 5/00

(52) U.S. Cl. CPC B66B 11/0246; B66B 5/005

(57) ABSTRACT

The invention relates to an elevator arrangement comprising an elevator with an inspection or maintenance mode controlled by a maintenance control unit, which elevator further comprises an elevator car and a counterweight or balance weight, and which elevator car is equipped with a roof. The elevator car comprises at least at one upper corner inside the elevator car a sheltered casing inside which at least a part of the electric appliances of the elevator car is situated, and that the roof is arranged to open outwards from the elevator car in order to form a working connection from inside the elevator car to the elevator shaft, and to open an access to the casing.

This application is a continuation of PCT International Application No. PCT/FI2016/050525 which has an International filing date of Jul. 15, 2016, the entire contents of which are incorporated herein by reference.

The present invention relates to an elevator arrangement for safe maintenance work as defined in the preamble of claim 1.

The safe maintenance work in this connection means all the work that is done when an inspection mode is switched on. In that mode inspection, adjustment, maintenance and repair works are usually done for the elevator.

The invention in question relates particularly to an elevator where a headroom in the elevator shaft is low. In elevators like this usually no additional material can be placed outside the elevator car, particularly onto the roof of the elevator car.

The headroom in this context means the clearance between the roof of the elevator car and the ceiling of the elevator shaft in the situation when the elevator car is at its uppermost position. Various tasks, such as inspections, adjustment works, maintenance or repairs, later referred in a shorter way only as “maintenance work”, are often performed at the upper part of the elevator shaft. In that case the safety of the persons performing the tasks mentioned above has always to be secured. If the height of the top clearance of the elevator shaft is low, in other words the headroom is low, a sufficient safety space, which prevents injuries occurring for persons working on the roof of the elevator car, cannot always be guaranteed without special procedures.

Usually the maintenance work is done on the roof of the elevator car. In that case, when working on the roof of the elevator car an unintentional movement of the elevator car must be prevented in some other way than by the regular operating brakes of the elevator. It is known in the prior art that this kind of prevention can be done by locking the elevator car and/or the counterweight into their positions on the guide rail, for instance by means of a safety gear, a latch or wedges. However, this often requires that the working persons must separately go to the elevator shaft and perform the locking. That makes safety preparation tasks awkward, laborious and time-consuming.

Another solution according to prior art for achieving an adequate safety space in the upper part of an elevator shaft is to use one or more turnable buffers that are disposed below the counterweight. The buffer is lifted upright before going onto the roof of the elevator car. The length of the buffer is such that the movement of the counterweight, and at the same time the movement of the elevator car, stops before the elevator car rises too high with respect to the ceiling of the elevator shaft. One problem, among others, in this solution is, however, that the shaft space might have been dimensioned so precisely that there is no proper space in the bottom part of the elevator shaft for a turnable buffer. Another problem is that the aforementioned buffer ensuring the top safety space is in the bottom part of the elevator shaft, i.e. right at the other end of the elevator shaft. In that case setting the buffer into the safe position takes extra time and it may also happen that for this reason the person in charge does not remember to go down to the bottom of the elevator shaft to turn them into the safe position.

In addition to the aforementioned, the safety solutions are often based on electrical supervision controls installed in the doors of the shaft, which controls must be switched to the safe position before going onto the roof of the elevator car. Turning the buffers into the safe position and activation of the electrical control circuits are often such a complex combination that, particularly e.g. with small tasks, they might be left undone owing to their complexity and for saving the time used. In addition, electrical supervision control systems are susceptible to failure.

Yet one solution according to the prior art is shown in the US patent publication No. US2010/0200339 A1. The solution according to the US publication presents an elevator safety system for elevators with a reduced upper end of the elevator shaft. In this solution the roof of the elevator car cannot be used as a working base, because the roof of the elevator car is constructed so that it does not support weight. Thus, it is not possible to be or work on the roof of the elevator car. In this case the required free safety space is formed completely inside the elevator car when the elevator car is in its uppermost position. As the roof is not designed to bear loads, in such a situation a weight on the roof may deform or even broke the roof structures. The maintenance work at the top part of the elevator shaft is done inside the elevator car. For this purpose a part of the sidewall of the car is made removable and the maintenance work is done though the opening in the sidewall when the part mentioned above has been removed from the sidewall.

However, the problem in this solution is the fact that there are only limited possibilities to make inspection, repair and maintenance work because only one certain opening is used. And likewise there are limited possibilities to place elevator appliances that require regular maintenance in the elevator shaft because the opening is only at one sidewall of the car. In addition the opening makes the wall structure more expensive, more complicated and also weaker than the unbroken wall structure.

One objective of the present invention is to eliminate drawbacks of prior art technology and to achieve an elevator arrangement where the headroom at the upper part of the elevator shaft can be as low as possible, and the elevator shaft is completely inside the building so that there is no need to penetrate the roof of the building. Another objective of the present invention is to achieve a safe space for maintenance work of the elevator appliances in the elevator shaft, and make it possible to perform maintenance work from inside the elevator car. And yet another objective of the present invention is to achieve an arrangement that is operationally extremely reliable, easy and fast to use, and where all the control appliances for maintenance work are inside the elevator car. Yet another objective of the present invention is to achieve an arrangement where the top part of the elevator shaft is marked so that persons working in the elevator car can easily see when the moving elevator car is approaching the ceiling of the elevator shaft.

The elevator arrangement according to the invention is characterized by what is disclosed in the characterization part of claim 1. Other embodiments of the invention are characterized by what is disclosed in the other claims.

The inventive content of the application can also be defined differently than in the claims presented below. The inventive content may also consist of several separate inventions, especially if the invention is considered in the light of expressions or implicit sub-tasks or from the point of view of advantages or categories of advantages achieved. In this case, some of the attributes contained in the claims below may be superfluous from the point of view of separate inventive concepts. Likewise the different details presented in connection with each embodiment can also be applied in other embodiments. In addition it can be stated that at least some of the subordinate claims can, in at least some situations, be deemed to be inventive in their own right.

In order to achieve the objectives mentioned above, the present invention provides an elevator arrangement comprising an elevator with an elevator operating system, a control system, and an inspection or maintenance mode controlled by a maintenance control unit, which elevator further comprises an elevator car arranged to run up and down in an elevator shaft along its guide rails, and which elevator car is equipped with a roof. Advantageously the elevator car comprises at least at one upper corner inside the elevator car a sheltered casing inside which at least a part of the electric appliances of the elevator car is situated, and that the roof is arranged to open outwards from the elevator car in order to form a working connection from inside the elevator car to the elevator shaft, and to open an access to the casing. The operating system basically provides the functions of the elevator arrangement and the control system is basically for controlling and regulating the operating system. These operating system and control system may comprise sub-systems some of them inter-relating and some of them being independent.

One advantage of the invention is that the invention enables a safe way of providing an elevator that has an extremely low top clearance or headroom. The top clearance can even be minimized to the minimum, or close to the minimum, required only by the trajectory of the elevator car. Thus when the elevator car is in its uppermost possible position on its trajectory, the shaft space above the elevator car is small and the height of the elevator shaft can easily be fitted inside the building, without penetrating the roof of the building. Another advantage is that invention enables a safer way to perform maintenance work because the persons can be inside the elevator car and all the needed buttons to control the movement of the elevator car are well accessible inside the elevator car. A further advantage is that car lighting and other electrical appliances, including printed circuit boards needed by an elevator car, a reserve battery with its charger, etc. and also apertures for elevator car ventilation can be situated in a covered space, such as corner casings, where they are sheltered, for example from vandalism. A further advantage is also that the solution is inexpensive and simple to implement. Yet a further advantage is that uplifted roof protects the working person in the elevator car from possible falling objects in the elevator shaft. Yet a further advantage is that the solution is very easy and quick to use, and does require neither awkward working in the elevator shaft nor preliminary procedures at the top end or bottom end of the elevator shaft. And yet a further advantage is that the working safety improves when driving the elevator car upwards at to upper area of the elevator shaft because the approaching of the elevator car to the ceiling of the elevator shaft can be better observed.

In an advantageous embodiment the roof of the elevator car is lifted to its upper position to enable a maintenance person to reach the maintenance work items outside the elevator car. After completing the maintenance work the roof is lowered to its closed position.

In the following, the invention will be described in detail by the aid of example embodiments by referring to the attached simplified and diagrammatic drawings, wherein

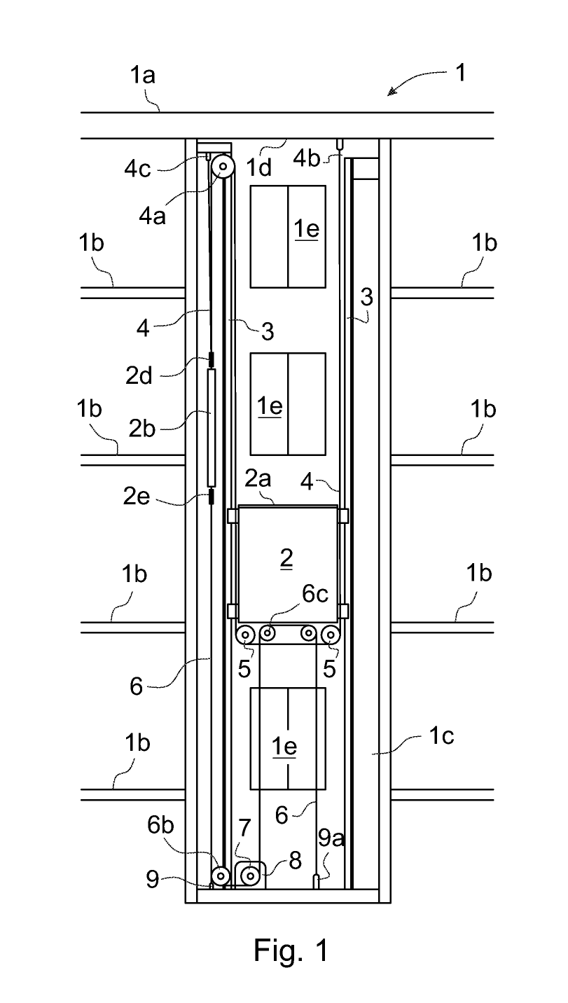

FIG. 1 presents in a simplified and diagrammatic back view a part of the building where the back wall of the elevator shaft is removed, and an elevator in the elevator shaft, in which elevator the solution according to the invention can be used,

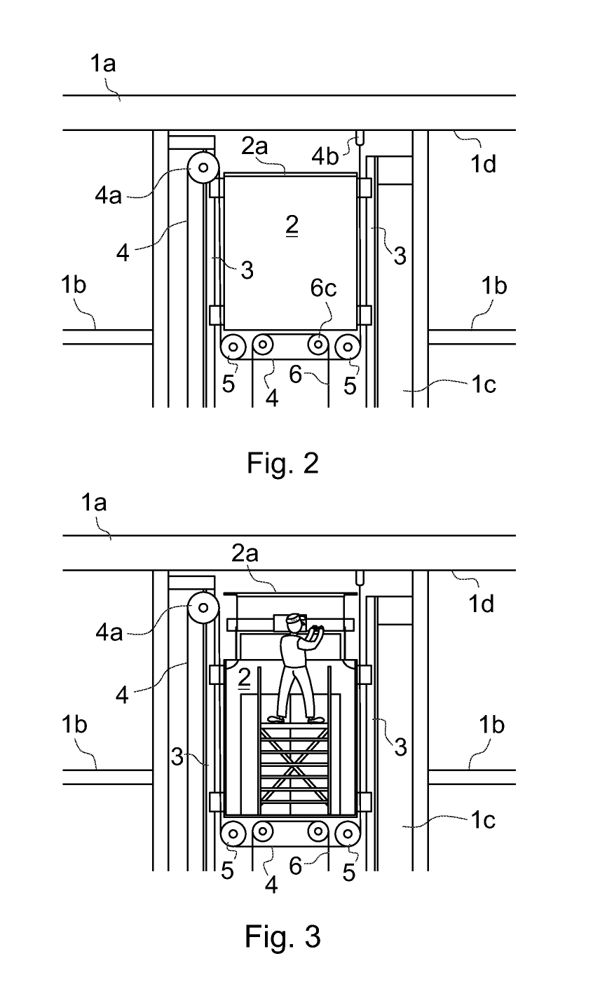

FIG. 2 presents in a simplified and diagrammatic back view the upper part of the elevator shaft in the building according to FIG. 1,

FIG. 3 presents in a simplified and diagrammatic back view the upper part of the elevator shaft in the building according to FIG. 1 in the situation where the maintenance or repair task is in progress,

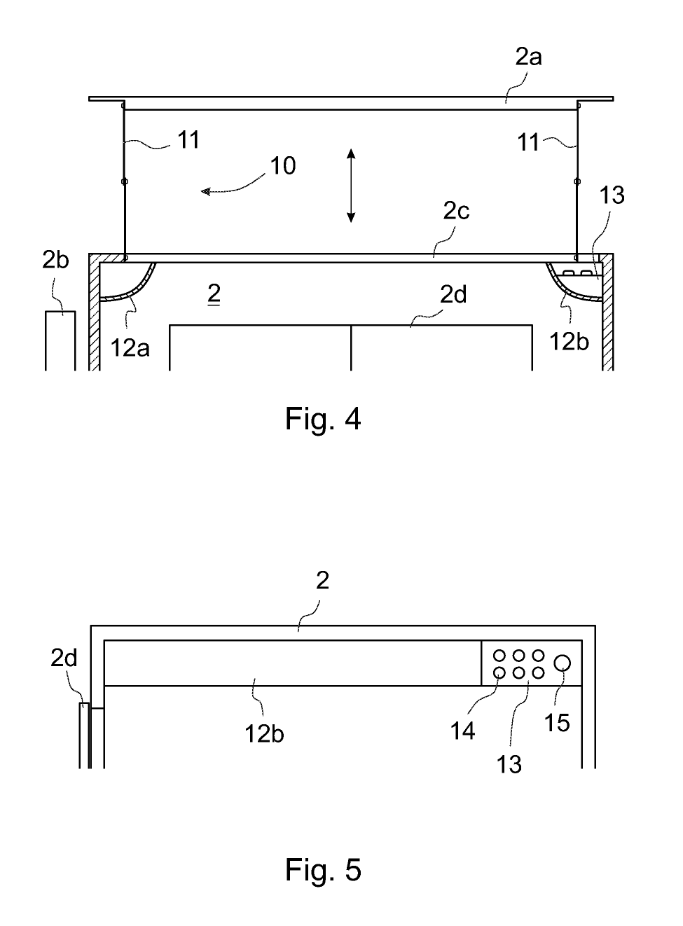

FIG. 4 presents in a simplified and diagrammatic back view an upper part of the elevator car according to the invention when the roof is lifted upwards for maintenance work,

FIG. 5 presents in a simplified and diagrammatic top view one side of the elevator car according to FIG. 4 when the roof is lifted upwards,

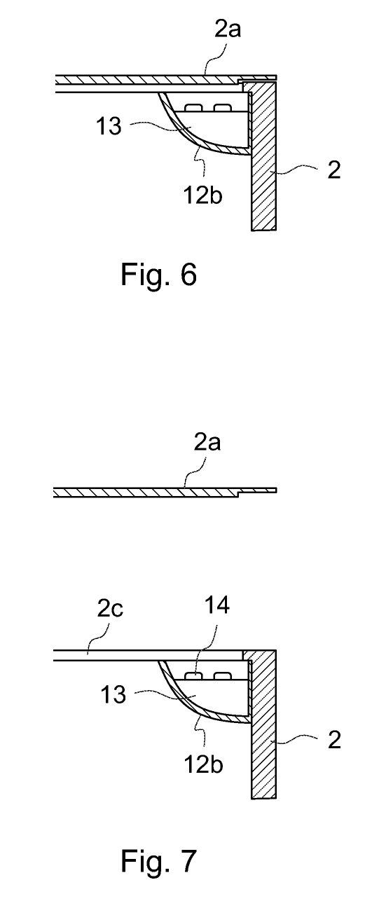

FIG. 6 presents in a simplified and diagrammatic enlarged view an upper corner of the elevator car according to FIG. 4 when the roof is in its closed position,

FIG. 7 presents in a simplified and diagrammatic enlarged view an upper corner of the elevator car according to FIG. 4 when the roof is lifted upwards,

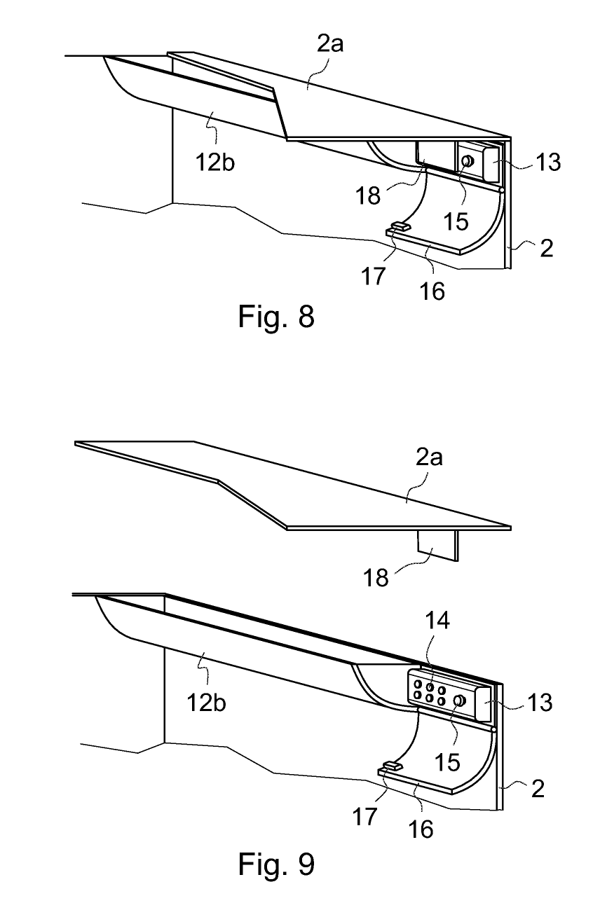

FIG. 8 presents in a simplified and diagrammatic oblique top view an upper part of the elevator car according to another embodiment of the invention when the roof is in its closed position, and

FIG. 9 presents in a simplified and diagrammatic oblique top view an upper part of the elevator car according to FIG. 8 when the roof is lifted upwards.

An aspect of the invention is to achieve in every respect a safe elevator arrangement with an elevator car having an openable roof which makes it possible to safely access maintenance and repair targets in an elevator shaft from inside the elevator car, and which also removes the need to step onto the roof of the elevator car, and in addition which also reduces the height of the shaft needed, and in which elevator car lighting and other electrical appliances needed by the elevator car are situated in a covered space where they are sheltered from outsiders.

FIG. 1 presents in a simplified and diagrammatic back view a part of the building 1 where the back wall of the elevator shaft 1c is removed, and an elevator in the elevator shaft 1c, in which elevator the solution according to the invention can be used. The building 1 has a roof 1a just above the elevator shaft 1c and four floors 1b served by the elevator.

The elevator comprises among other things an elevator car 2 with an openable roof 2a, which elevator car 2 is arranged to run up and down in the elevator shaft 1c along guide rails 3, and a counterweight or balance weight 2b that is also arranged to run up and down in the elevator shaft 1c along its guide rails which are not presented in FIG. 1 for the sake of clarity. Later in this connection only balance weight 2b is mentioned when either counterweight or balance weight is meant.

Advantageously the supporting and moving of the elevator car 2 are separated from each other. This makes it possible to achieve an elevator structure where the height of the headroom above the elevator car 2 can be is low as possible. The elevator car 2 is driven by a hoisting machinery 8 equipped with a drive wheel 7. Advantageously the hoisting machinery 8 is located at the bottom part of the elevator shaft 1c, below the elevator car 2 and advantageously below the first floor level 1b.

A traction member 6 is connected between the balance weight 2b and the elevator car 2. The traction member 6 can be a single member or a bunch of similar parallel members, for instance, the traction member 6 can be a toothed belt, chain or other type of member that does not slip on the drive wheel 7. In this embodiment the suspension ratio of the traction member 6 is 2:1. In that case the first end of the traction member 6 is secured at its first fastening point 9, for example at the bottom part of the elevator shaft 1c. From the first fastening point 9 the traction member 6 is led upwards to go over and around a traction sheave 2e in connection with the balance weight 2b and from the traction sheave 2e the traction member 6 is led downwards to go under and around a diverting pulley 6b and the drive wheel 7 of the hoisting machinery 8 at the bottom part of the elevator shaft 1c, from where the traction member 6 continues upwards to go over and around diverting pulleys 6c at the bottom of the elevator car 2 and from the diverting pulleys 6c again downwards to its second fastening point 9a where the second end of the traction member 6 is secured, for example at the bottom part of the elevator shaft 1c.

The elevator car 2 is suspended by suspension element 4 that is connected between the balance weight 2b and the elevator car 2. The suspension element 4 can be a single member or a bunch of similar parallel members, for instance suspension ropes. In this embodiment the suspension ratio of the suspension element 4 is 2:1. In that case the first ends of the suspension element 4 are secured at their first fastening point 4c, for example at the top part of the guide rail 3, from which the suspension element 4 is led downwards to go under and around a diverting pulley 2d in connection with the balance weight 2b. From the diverting pulley 2d the suspension element 4 is led upwards to go over and around a diverting pulley 4a that is fitted with bearings on its shaft, for instance at the upper part of the guide rail 3. From the diverting pulley 4a the suspension element 4 descends downwards to go under and around diverting pulleys 5 at the bottom of the elevator car 2 and from the diverting pulleys 5 the suspension element 4 is led upwards to its second fastening point 4b where the second end of the suspension element 4 is secured, for example at the top part of the guide rail 3. The elevator car 2 is also equipped with safety gear system that is arranged to stop the movement of the elevator car 2 and to lock the elevator car 2 into the guide rails 2 when needed. Thanks to the suspension like this the roof 2a of the elevator car 2 can be openable.

Each floor has a landing door 1e that is presented in FIG. 1 seen from the direction of the elevator shaft 1c. In addition the elevator comprises at least an operating system, a control system, an electrical system, a variety of sensor arrangements and a safety system comprising an inspection mode, which inspection mode is here a common term for the operation mode which is activated when performing inspection, maintenance or repair work or other operations that require a safe working environment.

FIG. 2 presents in a simplified and diagrammatic back view the upper part of the elevator shaft 1c in the building 1 according to FIG. 1. Also in this figure the back wall of the elevator shaft 1c is removed and the elevator shaft 1c is seen from its backside. In the situation of FIG. 2 the elevator car 2 is in its uppermost floor 1b in the top part of the elevator shaft 1c. The top clearance between the roof 2a of the elevator car 2 and the ceiling 1d of the elevator shaft 1c is at its minimum.

FIG. 3 presents in a simplified and diagrammatic back view the upper part of the elevator shaft 1c in the building 1 according to FIG. 1 in the situation where the maintenance or repair task is in progress. The openable roof 2a of the elevator car 2 is opened by lifting it upwards in this embodiment, and a maintenance hole or opening is created between the uplifted roof 2a and the upper edges of the elevator car 2. The elevator car 2 has been run with a service run or inspection run in an appropriate location in the elevator shaft 1c so that the working person being inside the elevator car 2 has an easy access to the elevator components and appliances in the elevator shaft. In this case the required safety space is created at least partly inside the elevator car 2. The uplifted roof 2a protects the working person also from falling tools and other objects that may fall down into the elevator shaft 1c from other working sites above, for instance from a top part of a neighboring elevator shaft where another elevator is installed at the same time.

FIG. 4 presents in a simplified and diagrammatic view, an upper part of the elevator car 2 according to the invention. In the embodiment of FIG. 4 the roof 2a is open for a maintenance or repair work and a created manhole or opening 2c on top of the elevator car 2 makes it possible to reach to the elevator appliances or components in the elevator shaft 1c from inside the elevator car 2. In FIG. 4 the back walls of the elevator shaft 1c and the elevator car 2 are removed and the elevator shaft 1c and elevator car 2 are seen from their backside.

In the embodiment of FIG. 4 the roof 2a is openable by lifting it straight upwards. For that purpose the elevator comprises opening means 10 that are arranged to open and close the roof 2a when the elevator is switched on to a safe inspection or maintenance mode, later in a shorter way referred only as “inspection mode”. The moving of the roof 2a can be carried out in several ways. One way is to use articulated arms 11 and one or more actuators, for example gas springs to turn the articulated arms 11. In this embodiment four articulated arms 11 are used, two pieces on each side of the elevator car 2. The actuators are not presented in the FIG. 4.

FIG. 4 also presents corner casings 12a, 12b that are fastened at opposite upper corners inside the elevator car 2, preferably onto the side walls of the elevator car 2 but possibly also to the under surface of the roof 2a. The corner casings 12a, 12b may comprise car lighting and other electrical appliances, including all printed circuit boards needed by an elevator car, a reserve battery with its charger, and also apertures for elevator car ventilation.

FIG. 5 presents in a simplified and diagrammatic top view one side of the elevator car 2 according to FIG. 4 when the roof 2a is lifted upwards. The roof 2a is not shown in FIG. 5. In the embodiments of FIGS. 4 and 5 the second corner casing 12b comprises among other things a maintenance control unit 13 with operating buttons 14, such as inspection mode buttons, a stop button 15 and, if needed, also an opening mechanism of the locking of the roof 2a.

One significant safety aspect of the solution according to the invention is that the corner casing 12b comprising the maintenance control unit 13 is placed in the opposite side corner of the elevator car 2 compared to the balance weight 2b. Thus, the balance weight 2b is on the first side of the elevator car 2 and the corner casing 12b is in the upper corner of the opposite side of the elevator car 2. This solution improves safety because now the person working in the elevator car 2 is as far as possible from the balance weight 2b and the risk to be injured as a result of a collision with the balance weight 2b is minimized.

FIGS. 6 and 7 present in a simplified and diagrammatic enlarged view an upper corner of the elevator car 2 according to FIG. 4. In FIG. 6 the roof 2a is in its closed position, and in FIG. 7 the roof 2a is lifted upwards. In this embodiment the maintenance control unit 13 with the operating buttons 14 is facing upwards towards the roof 2a that closes the maintenance control unit 13 when the roof 2a is in its closed position, as is seen in FIG. 6. The lower surface of the roof 2a is so close to the upper edge of the corner casing 12b that an access to the maintenance control unit 13 is prevented when the roof 2a is in its closed position. Correspondingly the access to the maintenance control unit 13 is allowed when the roof 2a is in its open position, as is seen in FIG. 7.

FIGS. 8 and 9 present in a simplified and diagrammatic oblique top view an upper part of the elevator car according to another embodiment of the invention. In FIG. 8 the roof 2a is in its closed position, and in FIG. 9 the roof 2a is lifted upwards. In this embodiment the maintenance control unit 13 is behind a separate hinged lid 16 that can be opened though the roof 2a is in its closed position. The lock 17 of the lid 16 can be opened with a special key, for example with the same key as the control center of the elevator or with a so-called triangle key that is used to open landing doors 1e in the inspection mode.

For safety reasons only the stop button 15 is seen when the lid 16 is opened if the roof 2a is in its closed position. Other operating buttons 14 are covered by a blocking element 18, such as a vertical plate, that is fastened at its upper edge, for example to the lower surface of the roof 2a. In this situation the elevator cannot be run in the inspection mode because the operating buttons are not available. When the roof 2a is lifted upwards the blocking element 18 lifts simultaneously upwards and away from the front of the operating buttons 14. Now the operating buttons 14 are available and it is possible to run the elevator in the inspection mode. The rest of the corner casing 12b comprises, for example lighting and other electrical appliances as mentioned above.

When the roof 2a is lifted upwards it may be difficult to see from inside the elevator car 2 the exact position of the elevator car 2. That may cause risks when driving the elevator car 2 upwards near the top of the elevator shaft 1c. To minimize that kind of risk situations the upper end of the elevator shaft 1c is equipped with a clear warning sign that can easily be seen from inside the elevator car 2. The warning sign can be, for instance, a colorful vertical paint stripe on an inner wall of the elevator shaft 1c extending a certain distance downwards from the ceiling 1d of the elevator shaft 1c. The stripes can be more than one, and on more than one wall, and also the whole upper part of the elevator shaft 1c can be painted in different color. The different color can extend downwards from the ceiling 1d of the elevator shaft 1c, for example about 2 to 3 meters. This kind of a warning sign gives the person working in the elevator car 2 time to prepare himself/herself to stop the elevator car 2 to the service limit. If, for some reason, the elevator car passes the service limit the person can prepare himself/herself for the collision with the ceiling 1d of the elevator shaft 1c. Instead of using paint separate bars, ribbons or tapes of different color can be fastened onto the walls of the upper part of the elevator shaft 1c.

It is obvious to the person skilled in the art that the invention is not restricted to the examples described above but that it may be varied within the scope of the claims presented below. Thus, for instance the roof of the elevator car and the mechanisms for opening and closing the roof can be different from what is presented above. For instance, the roof can be opened around a hinge to one side of the elevator car or from the middle to two sides of the of the elevator car or the roof can be a flexible element comprising narrow slats, which are connected to each other in a way that they can make a part of the roof bend downwards at the upper corner of the elevator car when the roof is opening and sliding away from the top of the manhole or the opening of the elevator car.

It is also obvious to the person skilled in the art that the suspension and/or traction ratio of the elevator car can be different from what is presented above. The suspension and/or traction ratio can be, for instance 1:1, the suspension ratio can also be 2:1 but the traction ratio 1:1. However, it is essential that the elevator structure is such that the roof of the elevator car can be easily opened.

It is further obvious to the person skilled in the art that the suspension and traction arrangement of the elevator car can be different from what is presented above. The location of the hoisting machinery can also be in the upper part of the elevator shaft, and the suspension and traction of the elevator car can be carried out in different ways, for instance with common hoisting ropes that suspend the elevator car and the balance weight and also moves them.

1. Elevator arrangement comprising an elevator with an elevator operating system, a control system, and an inspection or maintenance mode controlled by a maintenance control unit, which elevator further comprises an elevator car arranged to run up and down in an elevator shaft along its guide rails, and which elevator car is equipped with a roof, wherein the elevator car comprises at least at one upper corner inside the elevator car a sheltered casing inside which at least a part of the electric appliances of the elevator car is situated, and that the roof is arranged to open outwards from the elevator car in order to form a working connection from inside the elevator car to the elevator shaft, and to open an access to the casing.

2. Elevator arrangement according to claim 1, wherein the maintenance control unit is at an inner upper part of the elevator car under the roof of the elevator car, and the roof is arranged to open an access to the maintenance control unit.

3. Elevator arrangement according to claim 1, wherein the elevator comprises opening means that are arranged to open and close the roof when the elevator has been switched on to the inspection or maintenance mode.

4. Elevator arrangement according to claim 1, wherein the elevator comprises a counterweight or balance weight.

5. Elevator arrangement according to claim 4, wherein the maintenance control unit is on the opposite side of the elevator car compared to the counterweight or balance weight.

6. Elevator arrangement according to claim 1, wherein the maintenance control unit comprises operating buttons and a stop button, and that in its closed position the roof is arranged to close the access to the operating buttons of the maintenance control unit.

7. Elevator arrangement according to claim 1, wherein the maintenance control unit is inside the casing, and that in its closed position the roof is arranged to close the access to the corner casing and to the maintenance control unit from upwards.

8. Elevator arrangement according to claim 1, wherein the maintenance control unit is on the extension of the casing behind a separate lid that is arranged be opened regardless of the position of the roof.

9. Elevator arrangement according to claim 8, wherein a blocking element is fastened to the lower surface of the roof to move with the roof and to prevent access to the operating buttons of the maintenance control unit when the roof is in its closed position.

10. Elevator arrangement according to claim 8, wherein the lid comprises a lock that is arranged to be opened with the same key as the control center of the elevator or with the same key as is used to open landing doors of the elevator in the inspection mode.

11. Elevator arrangement according to claim 1, wherein the upper end of the elevator shaft is equipped with a warning sign that is arranged to be seen from inside the elevator car.

12. Elevator arrangement according to claim 11, wherein the warning sign extends a certain distance downwards from the ceiling of the elevator shaft, and that warning sign is on one or more walls of the elevator shaft, and that the warning sign is one or more from the following: a colorful vertical paint stripe on the inner wall or walls of the upper part of the elevator shaft, one or more bars, ribbons or tapes of different color fastened onto the wall or walls of the upper part of the elevator shaft.

13. Elevator arrangement according to claim 1, wherein the opening means are arranged to open and close the roof essentially in a vertical direction.
